(19) United States
(12) Patent Application Publication
(10) Pub. No.: US 2016/0301849 A1
(43) Pub. Date: Oct. 13, 2016

(54) PORTABLE APPARATUS AND METHOD FOR WIRELESSLY CONTROLLING A CONTROLLED DEVICE BY USING A MOBILE TERMINAL

(71) Applicant: BEIJING MEIXUN MEITONG INFORMATION TECHNOLOGY CO., LTD., Chaoyang District, Beijing (CN)

(72) Inventor: Wenxuan E, Beijing (CN)

(21) Appl. No.: 14/381,929

(22) PCT Filed: Mar. 5, 2014
(86) PCT No.: PCT/CN2014/072931

§ 371 Date: Aug. 28, 2014

(30) Foreign Application Priority Data
Feb. 28, 2014 (CN) PCT/CN2014/072748

(51) Int. Cl. H04N 5/232; H04M 1/725; H04N 1/00

(52) U.S. Cl. CPC H04N 5/23203; H04N 1/00307; H04N 5/23216; H04M 1/72533; H04N 2201/0084; H04N 2201/0055; H04N 2201/0075

(57) ABSTRACT

It is provided a portable apparatus and method for using a mobile terminal to wirelessly control a controlled device, the portable apparatus including: a first signal transceiver configured to wirelessly receive and transmit a first signal from and to a mobile terminal through a first wireless communication protocol; a controller configured to parse the received first signal to obtain a control command, and generate a second signal associated with the control command and to be transmitted to the controlled device according to the control command; a second signal transmitter configured to wirelessly transmit the second signal to the controlled device according to the control command through a second wireless communication protocol, so that the controlled device performs operations corresponding to the control command according to the second signal; and a built-in power supply configured to supply power to the portable apparatus itself.

### TECHNICAL FIELD

This disclosure relates to wireless communication field, and more particularly, to an apparatus and method for wirelessly controlling a controlled device by using a mobile terminal.

### BACKGROUND

With the popularity of various electrical appliances such as digital cameras and Digital Single Lens Reflex (DSLR) cameras, more and more people are used to use the various electrical appliances.

For example, people who like to take photos and travel often carry such digital camera and/or DSLR camera to take photos of views. Normally, people carry the camera with one hand, and press the shutter on the camera with the other hand to take photos. However, pressing the camera shutter with a hand to take photos incurs various problems. For example, the camera needs to be stationary when taking photos with slow shutter, and sometimes even with a tripod leg, some shakes may occur due to pressing the camera shutter with hands, so as to cause blurs in photos. For example, when taking group photos with the photographer himself/herself, he/she needs to set the delay shutter on the camera, and rapidly run to the photo taking place after pressing the shutter, and in this case, due to the fixed time delay, people may not run to the right place or may have a wrong face. For example, sometimes, people need to take photos in bad environment such as cold environment, for example to take photos of blizzard, lightening, sunrise, and so on, and if people have to stand by the camera to wait, this will cause bad user experience. In addition, when people need to perform time-lapse photography, for example, when taking a series of photos of changing clouds, people need to press the shutter each time at certain intervals, which requires people to go back to the camera and perform shutter press at certain intervals, which is very inconvenient and ineffective. Similarly, for other electrical appliances such as cameras, recorders, projectors, televisions, air-conditioners and so on, there are similar drawbacks.

Thus, a portable solution with better user experience is required for wirelessly remotely controlling electrical appliances.

### INVENTION SUMMARY

The inventor develops a portable apparatus and method for wirelessly controlling a controlled device such as a camera by using a mobile terminal such as a mobile phone.

According to an aspect of the present disclosure, it is provided a portable apparatus for wirelessly controlling a controlled device by using a mobile terminal, comprising: a first signal transceiver configured to wirelessly receive and transmit a first signal from and to a mobile terminal through a first wireless communication protocol; a controller configured to parse the received first signal to obtain a control command, and generate a second signal associated with the control command and to be transmitted to the controlled device according to the control command; a second signal transmitter configured to wirelessly transmit the second signal to the controlled device according to the control command through a second wireless communication protocol, so that the controlled device performs operations corresponding to the control command according to the second signal; and a built-in power supply configured to supply power to the portable apparatus itself.

According to another aspect of the present disclosure, it is provided a method for a portable apparatus to use a mobile terminal to wirelessly control a controlled device, comprising: wirelessly receiving and transmitting a first signal from and to a mobile terminal through a first wireless communication protocol, by a first signal transceiver; parsing the received first signal to obtain a control command, and generate a second signal associated with the control command and to be transmitted to the controlled device according to the control command, by a controller; wirelessly transmitting the second signal to the controlled device according to the control command through a second wireless communication protocol, by a second signal transmitter, so that the controlled device performs operations corresponding to the control command according to the second signal; and supplying power to the portable apparatus itself, by a built-in power supply.

According to another aspect of the present disclosure, it is provided a non-transitory computer recordable medium on which a computer executable program is recorded, the computer executable program, when being run, making a portable apparatus to perform a method for a portable apparatus to use a mobile terminal to wirelessly control a controlled device, the method comprising: wirelessly receiving and transmitting a first signal from and to a mobile terminal through a first wireless communication protocol, by a first signal transceiver; parsing the received first signal to obtain a control command, and generating a second signal associated with the control command and to be transmitted to the controlled device according to the control command, by a controller; wirelessly transmitting the second signal to the controlled device according to the control command through a second wireless communication protocol, by a second signal transmitter, so that the controlled device performs operations corresponding to the control command according to the second signal; and supplying power to the portable apparatus itself, by a built-in power supply.

According to another aspect of the present disclosure, it is provided a computer executable program, when being run, making a portable apparatus to perform a method for a portable apparatus to use a mobile terminal to wirelessly control a controlled device, the method comprising: wirelessly receiving and transmitting a first signal from and to a mobile terminal through a first wireless communication protocol, by a first signal transceiver; parsing the received first signal to obtain a control command, and generating a second signal associated with the control command and to be transmitted to the controlled device according to the control command, by a controller; wirelessly transmitting the second signal to the controlled device according to the control command through a second wireless communication protocol, by a second signal transmitter, so that the controlled device performs operations corresponding to the control command according to the second signal; and supplying power to the portable apparatus itself, by a built-in power supply.

According to another aspect of the present disclosure, it is provided a method for a mobile terminal to use a portable apparatus according to an aspect of the present disclosure to wirelessly control a controlled device, comprising:

in response to receiving an externally input operative instruction, converting the operative instruction into an operative instruction signal in conformity to a first wireless communication protocol;

transmitting the operative instruction signal to the portable apparatus according to an aspect of the present disclosure through the first wireless communication protocol, so that under power supply of a built-in power supply, the portable apparatus according to an aspect of the present disclosure parses the received operative instruction signal to obtain a control command, generates a second signal associated with the control command and to be transmitted to the controlled device according to the control command, and wirelessly transmits the second signal to the controlled device according to the control command, causing the controlled device to perform operations corresponding to the control command according to the second signal.

According to another aspect of the present disclosure, it is provided a system for a mobile terminal to use a portable apparatus according to an aspect of the present disclosure to wirelessly control a controlled device, comprising: a conversion means configured to, in response to receiving an externally input operative instruction, convert the operative instruction into an operative instruction signal in conformity to a first wireless communication protocol; a transmission means configured to transmit the operative instruction signal to the portable apparatus as claimed in claim 1 through the first wireless communication protocol, so that under power supply of a built-in power supply, the portable apparatus as claimed in claim 1 parses the received operative instruction signal to obtain a control command, generates a second signal associated with the control command and to be transmitted to the controlled device according to the control command, and wirelessly transmits the second signal to the controlled device according to the control command, causing the controlled device to perform operations corresponding to the control command according to the second signal.

According to another aspect of the present disclosure, it is provided a non-transitory computer readable medium, on which a computer executable program is recorded, the computer executable program, when being run, causing a mobile terminal to perform the method for using a portable apparatus according to an aspect of the present disclosure to wirelessly control a controlled device.

According to another aspect of the present disclosure, it is provided a computer executable program, the computer executable program, when being run, causing a mobile terminal to perform the method for using a portable apparatus according to an aspect of the present disclosure to wirelessly control a controlled device.

Thus, according to the respective aspects of the present disclosure, it is possible to enable a user to leave the controlled device such as a camera, use the mobile terminal such as a mobile phone to flexibly control the controlled device to perform desired operations, such as instant shutter, delay shutter, time-lapse photography and so on, and the above portable apparatus can be itself-powered, there is no need to be inserted into the controlled device or get power from other apparatuses, so that it is possible to meet the need in the case of no external power supply during an outdoor travel and so on.

### BRIEF INTRODUCTION TO DRAWINGS

FIG. 1 is an exemplified diagram showing an applicable scene where the respective aspects according to the present disclosure are applied.

FIG. 2 is a structural diagram showing a portable apparatus for using a mobile terminal to wirelessly control a controlled device according to an embodiment of the present disclosure.

FIG. 3A is an exemplified table showing a corresponding relationship between identifiers of self-defined control commands and the infrared instructions supported by cameras according to an embodiment of the present disclosure; and FIG. 3B is an exemplified table showing camera type identifiers and the supported operation type identifiers according to an embodiment of the present disclosure.

FIG. 4A and FIG. 4B are exemplified timing diagrams showing variations of broadcasting rate and communication rate of the portable apparatus for using the mobile terminal to wirelessly control a controlled device according to an embodiment of the present disclosure and the mobile terminal in for example Bluetooth communication protocol, respectively, for a purpose of power-saving.

FIG. 5 shows a schematic diagram of a mobile terminal interface for implementing an instant shutter function according to an embodiment of the present disclosure.

FIG. 6A is a structural diagram showing a portable apparatus for using a mobile terminal to wirelessly control a controlled device according to another embodiment of the present disclosure; FIG. 6B is a schematic diagram showing a mobile terminal interface for implementing a time-lapse photography function according to an embodiment of the present disclosure; and FIG. 6C shows an exemplified timing diagram of the portable apparatus, as shown in FIG. 6A, in the case of time-lapse photography, using a timer to transmit an infrared signal to a controlled device through an infrared communication protocol, for a purpose of power-saving.

FIG. 7A is a structural diagram showing a portable apparatus for using a mobile terminal to wirelessly control a controlled device according to another embodiment of the present disclosure; FIG. 7B is an exemplified physical position at which the buzzer and/or the LED of the portable apparatus as shown in FIG. 7A is located; FIG. 7C is a schematic diagram showing a mobile terminal interface with a too-far alarm (anti-loss) function according to another embodiment of the present disclosure; and FIG. 7D is a schematic diagram showing a mobile terminal interface with a finding-apparatus function according to another embodiment of the present disclosure.

FIG. 8A is a structural diagram showing a portable apparatus for using a mobile terminal to wirelessly control a controlled device according to another embodiment of the present disclosure; and FIG. 8B is a schematic diagram showing an outer physical shape of an example of an input unit of the portable apparatus as shown in FIG. 8A.

FIG. 9A is a structural diagram showing a portable apparatus for using a mobile terminal to wirelessly control a controlled device according to another embodiment of the present disclosure; and FIG. 9B is a schematic diagram showing a mobile terminal interface with a thunderstorm alarm function according to another embodiment of the present disclosure.

FIG. 10A is a schematic diagram showing a mobile terminal interface with a highest-point photography function according to another embodiment of the present disclosure; and FIG. 10B is an illustrative diagram of an application scene of the highest-point photography function according to another embodiment of the present disclosure.

FIG. 11 is a structural diagram showing a portable apparatus for using a mobile terminal to wirelessly control a controlled device according to another embodiment of the present disclosure.

FIG. 12 is a flowchart showing a method for a portable apparatus for using a mobile terminal to wirelessly control a controlled device according to another embodiment of the present disclosure.

### DETAILED DESCRIPTION

Now particular embodiments of the present invention will be explained with reference to the drawings showing examples of the present invention. Although the present invention will be described in combination with the particular embodiments, to be understood that the present invention will not be limited to the described embodiments. Instead, it is intended that alterations, modifications and equivalents included in the spirit and scope of the present invention limited by the attached claims are covered. To be noted that the steps of the methods described herein can be implemented by any functional blocks or functional configurations, and any functional blocks or functional configurations can be implemented as physical entities, or logical entities, or a combination of the both.

In order for a person skilled in the art to understand the invention better, the invention will be further explained in combination with the drawings and detailed embodiments.

The invention will be explained in the following order:
1. Application scene example of the technology of the disclosure
2. General block diagram of a portable apparatus according to the technology of the disclosure
3. Self-defined command identifiers
4. Power saving design
5. Instant shutter function, instant f-number adjustment function, instant focus length adjustment function
6. Time-lapse photography function, delay shutter function, manual shutter adjustment function in the time-lapse photography and its power saving design
7. Too-far alarm (anti-loss) function, find-apparatus function
8. Mobile terminal self-photography function, find-mobile-terminal function
9. Thunderstorm alarm function
10. Highest-point photography function
11. Execution progress, various parameters inquiry function
12. General flowchart of a method according to the technology of the present disclosure

Application Scene Example of the Technology of the Disclosure

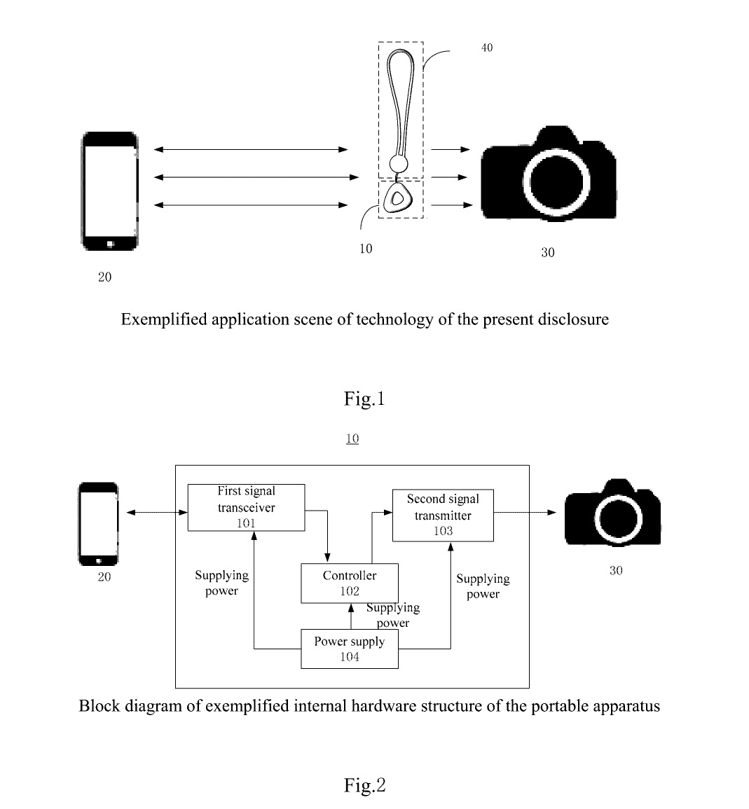

FIG. 1 is an example diagram showing an applicable scene where the respective aspects according to the present disclosure are applied.

As shown in FIG. 1, in the applicable scene where the respective aspects according to the present disclosure are applied, a mobile terminal 20 such as a mobile telephone wirelessly controls a controlled device 30 such as a camera via a portable device 10. In this example scene, the portable apparatus 10 is electrically isolated from the controlled device 20, and the portable apparatus is capable of being connected to the controlled device 20 through, preferably, an insulated flexible connecting unit 40. The flexible connecting unit 40 may be a rope connected with the portable apparatus 10, and the portable apparatus 10 can be hung on the controlled device 20 through the rope.

A user may operate related applications running on the mobile device 20 to remotely control the controlled device 30. For example, when the user presses some button in the application of the terminal device 20, the mobile device 20 can communicate with the portable apparatus 10, so that the terminal device 20 transmits signals, for example, a command for scanning the portable apparatus 10, a command for controlling the controlled device 30's operations, and so on, to the portable apparatus 10 and receives signals from the portable apparatus 10.

After the portable apparatus 10 receives commands for controlling the operations of the controlled device 30 transmitted from the mobile device 20, the portable apparatus 10 transmits a controlling signal to the controlled device 30 to control the operations of the controlled device 30. The portable apparatus can be self-powered, without external powers, so as to meet the requirement in the case of outdoors where there are no power supplies.

Thus, the user can easily use the portable mobile terminal 20 to remotely and wirelessly control the controlled device 30 through the portable apparatus that is also portable.

2. General Block Diagram of a Portable Apparatus According to the Technology of the Disclosure

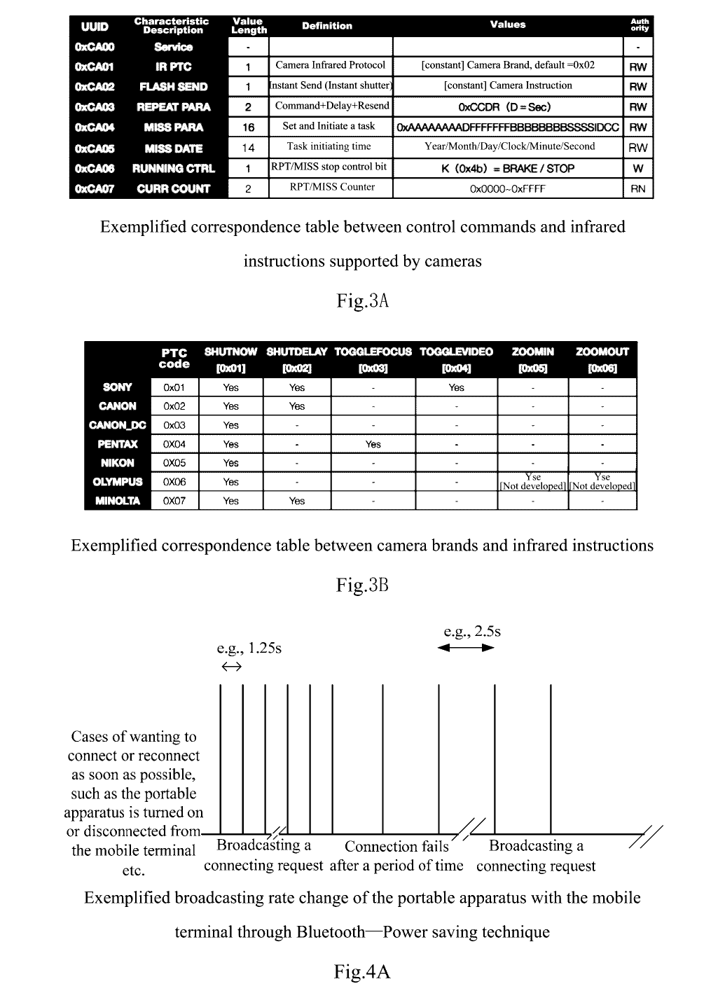

FIG. 2 is a structural diagram showing a portable apparatus 10 for using a mobile terminal to wirelessly control a controlled device according to an embodiment of the present disclosure.

The portable apparatus 10 for wirelessly controlling a controlled device by using a mobile terminal as shown in FIG. 2 includes: a first signal transceiver 101 configured to wirelessly receive and transmit a first signal from and to a mobile terminal through a first wireless communication protocol; a controller 102 configured to parse the received first signal to obtain a control command, and generate a second signal associated with the control command and to be transmitted to the controlled device 30 according to the control command; a second signal transmitter 103 configured to wirelessly transmit the second signal to the controlled device 30 according to the control command through a second wireless communication protocol, so that the controlled device 30 performs operations corresponding to the control command according to the second signal; and a built-in power supply 104 configured to supply power to the portable apparatus 10 itself.

Thus, it is enabled that the user can leave the controlled device and use the mobile terminal to flexibly control the controlled device to perform desired operations, and the above-mentioned portable apparatus can be self-powered, so there is no need to be inserted into the controlled device or get power from other devices, so as to meet the need in the case of outdoor travel and so on in which environment there are no external power supply.

Compared to remote controlling solutions such as the traditional wireless electric shutter technology, the traditional WiFi remote controlling camera technology, the present solution does not need to be inserted into the controlled device or get power from other devices, can be suitable for the case of long-time use without external power supply, can further avoid interface damage caused by being inserted into/removed from the controlled device, and can realize various controlling functions of the controlled device through the various functionalities of the mobile device. In addition, the solution uses the portable apparatus to convert the signals of the mobile device conforming to the first wireless communication protocol into the signals of various different controlled devices conforming to the different second wireless communication protocols, and can realize communication requirement between the mobile device and various different controlled devices, so as to realize the effect of controlling various different kinds of controlled devices.

In an embodiment, the portable apparatus 10 can be electrically isolated from the controlled device 30, and can be physically connected to the controlled device 30 through an insulated flexible connecting unit or a rigid connecting unit, preferably, be hung on the controlled device 30 through a flexible connecting unit such as a rope. As such, the portable apparatus 10 can easily be physically connected to the controlled device 30 insulatingly at any time, for the user's convenient use.

The number of the second signal transmitter 103 may be larger than 1, for example, 2, and located at the respective angles of the portable apparatus 10, so as to transmit a second signal omnidirectionally, so that the controlled device 30 can receive the second signal with no dead angle.

In an embodiment, the first wireless communication protocol may include a Bluetooth communication protocol, and the second wireless communication protocol may include an infrared communication protocol. The communication distance for the Bluetooth communication protocol is a maximum of nearly 30 m, and the communication distance for the infrared communication protocol is a maximum of nearly 5 m. Of course, the present disclosure is not limited to this, the first wireless communication protocol and the second wireless communication protocol may be different or the same. Each of the first wireless communication protocol and the second wireless communication protocol may include at least one of the following: Bluetooth communication protocol, Infrared communication protocol, WiFi or 802.11 B communication protocol, Zigbee, Ultra WideBand, Near Field Communication (NFC), WiMedia, Digital Enhanced Cordless Telecommunications (DECT), Wireless 1394 and so on and any possible future wireless communication protocols.

The controlled device 30 is a device capable of receiving an infrared signal to operate, such as, but not limited to, digital camera, DSLR, and so on, and the mobile terminal 20 is a device capable of receiving and transmitting a Bluetooth signal, such as, but not limited to a mobile telephone.

The controlled device 30 may include, for example, digital camera, DSLR, camcorder, recorder, projector, television (TV), air-conditioner and so on. The mobile terminal 20 may include, for example, mobile telephone, notebook computer, tablet computer, personal digital assistant (PDA), Bluetooth earphone, and so on.

In an embodiment, the control command may instruct at least one of the following operations: instant shutter, delay shutter, time-lapse photography, focusing, videotaping, adjusting the focus, adjusting the shutter speed, adjusting the aperture, manual shutter mode, instant power on/off, power on/off by alarm, and so on. The control command may include the type of the controlled device 30 (for example, camera or TV, or particular model number of the camera) and the type and the parameters of the operation to be executed by the controlled device 30 (for example, time-lapse photography and the start time, period and interval and number of photos of the time-lapse photography).

In an embodiment, after the portable apparatus is successfully connected with the mobile terminal, the built-in power supply 104 may supply a first power to the controller 102 and the first signal transceiver 101, so that the controller 102 exchanges basic data with the mobile terminal 20 at a first rate through the first signal transceiver 101, and after exchanging the basic data, the built-in power supply 104 may supply a second power to the controller 102 and the first signal transceiver 101, so that the controller 102 communicates with the mobile terminal at a second rate through the first signal transceiver 101, in which, the second power is lower than the first power, and the second rate is lower than the first rate. Thus, a high-rate power-consuming communication can be first utilized to perform basic data read and write required for communication connection, for example, the mobile device 20 scanning the portable apparatus 10, requesting parameter information of the portable apparatus 10, the portable apparatus 10 responding to the mobile device 20, and transmitting its own parameter information, or even communication frequency which is agreed on to be used; and then after the basic communication connection is completed, the power supply 104 can change to run with a low rate and low power consumption according to previously agreed communication frequency, and initiate the communication with the mobile device 20 only when the time period for the communication frequency is reached, and sleep for the rest of the time. As such, not only the first-time communication connection can be performed at a high rate, saving the user's waiting time, but also, the power is saved after the first-time communication connection, to maintain long use time, and provide good user experience to the user.

In an embodiment, in response to the controller not successfully connecting with the mobile terminal through the first signal transceiver within a predefined timeout period, the built-in power supply may supply a third power to the controller and the first signal transceiver, and broadcast a connecting request at a third rate. The third power is lower than the second power, and the third rate is lower than the second rate. Thus, even in the case of disconnecting from the mobile terminal, the power supply 104 can broadcast a connecting request at a lower rate, so as to further save power.

In an embodiment, the third rate may also be variable. In the case that the probability of the portable apparatus 10 connecting with the mobile terminal 20 is larger than a predefined possibility, the third rate is made to be larger than a predefined rate, while in the case that the probability of the portable apparatus 10 connecting with the mobile terminal 20 is not larger than a predefined possibility, the third rate is made to be not larger than a predefined rate. The case that the probability of the portable apparatus 10 connecting with the mobile terminal 20 is larger than a predefined probability may include, but is not limited to the following: in a period after the power supply 104 of the portable apparatus 10 is turned on; in a period after the portable apparatus 10 is disconnected from the mobile terminal 20; a case that other users may connect the portable apparatus 10 and the mobile terminal 20, and so on. For example, in the case that the power supply 104 of the portable apparatus 10 is initiated (for example, at the time of the first-time power on, i.e., the user turns on the power supply 104 of the portable apparatus 10 for the first time) (the case is normally the case that the user wants to connect with the mobile terminal 20 as soon as possible, so it is considered at this time that the probability of the portable apparatus 10 connecting with the mobile terminal 20 is relatively large), a relatively short interval, for example, 1.25 s can be used to broadcast the connecting request, and if, after for example 1 day, the connection still is not successful, then a relatively long interval of 2.5 s can be switched into to broadcast the connecting request. Again for example, within 1 day after the portable apparatus 10 disconnects from the mobile terminal 20 (for example, the user voluntarily terminates the connection of the portable apparatus 10 and the mobile terminal 20, or the mobile terminal 20 is offline, powered off, or goes far away from the connecting range, in this case, the probability of the user wanting to reconnect them is relatively large), the relatively short interval of for example 1.25 s is used to broadcast the connecting request, and if the connection is still not successful after 1 day, the relatively long interval of 2.5 s is switched into again. Of course, this is only an example, but not a limitation. As such, broadcasting the connecting request in a variable rate can further save power and greatly improve the user experience.

In an embodiment, the built-in power 104 may supply power to the second signal transmitter 103 only when it is to transmit the second signal to the controlled device 30, and stop supplying power to the second signal transmitter 103 after the second signal transmitter 103 transmits the second signal. In this way, the power is used only when it is substantively needed to transmit the second signal to the controlled device 30 to operate the controlled device 30, this can greatly save power, maintain long use time, and provide good user experience to the user without affecting the operations of the controlled device 30. Especially at the time of for example time-lapse photography of the camera, assuming that the user wants to take a photo every 1 minute, and take a total of 100 photos, so the power supply 104 can provide power to transmit a shutter operation signal until every 1 minute period is reached, without continuously supplying power.

In an embodiment, the control command may be comprised of different identifiers for different operations, and its data length is smaller than a predefined data length. In the present disclosure, the control command transmitted from the mobile device 20 to the portable apparatus 10 may be a short and unique self-defined identifier corresponding to a particular operation, without transmitting all the bytes of a complete particular operation itself, so this can further save power consumed by transmitting and receiving data.

In an embodiment, the portable apparatus 10 may further include: a timer, and the controller 102 is configured to, in response to the control command being parsed as a time-lapse photography command, make the timer periodically initiate the built-in power supply 104's power supply, according to the photography period instructed in the time-lapse photography command, so that the controller 102 generates a second signal associated with the instant shutter command, and transmits the second signal to the controlled device 30 through the second signal transmitter 103, causing the controlled device 30 to periodically execute the instant shutter operation.

In an embodiment, the portable apparatus 10 may further include: a buzzer and/or a light emitter diode (LED), wherein the controller 102 may be further configured to perform one or more of the following: in response to the control command being parsed as a distance-too-far alarm command, trigger the buzzer and/or LED to buzz and/or light, wherein the distance-too-far alarm command is issued when a distance between the mobile terminal 20 and the portable apparatus 10 as measured by he mobile terminal 20 exceeds a predefined distance threshold, in response to the signal power received by the first signal transceiver 101 is lower than the predefined power threshold or the power of the built-in power supply is lower than a predefined power threshold, trigger the buzzer and/or LED to buzz and/or light, in response to the control command being parsed as a find-apparatus command, trigger the buzzer and/or LED to buzz and/or light, wherein the find-apparatus command is issued by the mobile terminal 20 when a find-apparatus button on the mobile terminal 20 is clicked. Herein, in an example, the mobile terminal 20 may measure the amount of the Received Signal Strength Indication (RSSI) of the signal transmitted from the portable apparatus 10 and received at the mobile terminal 20, to correspond to the distance from the portable apparatus 10, i.e., when the RSSI of the received signal goes beyond the threshold range, it is considered that the distance from the portable apparatus 10 also goes beyond the threshold range, so that the portable apparatus 10 may buzz or light to notify the user. At the same time, the mobile terminal 20 itself may notify the user in the form of buzzing or splash screen or prompting dialog box. As such, this can prevent the controlled device 10 from being stolen, lost or being too far away to be unsafe.

In an embodiment, the portable apparatus 10 may further include: an input unit; wherein the controller 102 may be further configured to, in response to the input unit being input with an instruction, transmit an instruction to the mobile terminal 20 through the first communication transceiver 101, so that the mobile terminal 20 performs audio or video alarms, or camera shutter actions. The input unit may include physical buttons, virtual buttons, sliding member, audio input, sensor input and so on. As such, the input unit of the portable apparatus 10 is input with an input instruction (for example, the button is pressed down), so that the mobile terminal 20 performs audio or video alarm, for example, buzzing or splash screen, so that when the user is looking for the mobile terminal 20, it can prompt the user of where the mobile terminal 20 is located. Similarly, with the input unit of the portable apparatus 10 being input with an instruction (for example, the button is pressed down), a shutter action can be performed when the mobile terminal 20 is being in the camera-shooting progress, so that there is no need for the user to press the shutter button of the mobile terminal 20 with a hand to realize the self-photography action.

In addition, in the case that there is an input unit with only one button, long-time press (for example, pressing for more than 1.5 s) and short-time press (for example, pressing for less than 1.5 s) can be designed to distinguish different functions. Of course, the example of the input unit is not limited to this.

In an embodiment, the portable apparatus 10 may further include: an air pressure sensor configured to sense an air pressure. The controller 102 may be further configured to, in response to the air pressure sensed by the air pressure sensor exceeding a predefined air pressure threshold range, transmit an instruction to the mobile terminal 20 through the first communication transceiver 101, so that the mobile terminal 20 performs audio or video alarms. As such, when the air pressure is increased before thunderstorm, the user of the mobile terminal 20 can be informed so that the user may retrieve the controlled device 30 in time.

In an embodiment, the controller 102 may be further configured to, in response to the control command being parsed as a highest-point photography command, transmit a shutter command to the controlled device 30 through the second communication transmitter 103, so that the controlled device 30 performs the shutter operation. The highest-point photography command is issued by the mobile terminal when the mobile terminal 20 is determined to be at the jump highest point by using an acceleration sensor and/or a gyroscope. This is useful when the user needs to take a photo when jumping to the highest point, it can accurately judge when the user jumping with the mobile terminal 20 is at the jumping highest point, so that the user does not need to judge the highest-point timing by himself/herself.

In an embodiment, the portable apparatus 10 may further include: a storage configured to store at least one of the following: types of the controlled devices, and the corresponding executable operation types; the types and parameters of the operations to be executed in the control command; the execution progresses of the control commands and so on. The controller 102 of the portable apparatus 10 may be configured to, in response to the control command being parsed as an inquiry command, transmit the content to be inquired as stored in the storage to the mobile terminal 20 through the first communication transceiver 101. As such, the user can inquire the current state of the controlled device from the portable apparatus 10 through a different mobile terminal 20 (but not necessarily the mobile terminal 20 originally issuing the control command), for example, whether there is an on-going task, the type of the controlled device and the corresponding executable operation type, the type and parameter of the operation to be executed, execution progress and so on.

Thus, the user can easily use the portable mobile terminal 20 to remotely and wirelessly control the controlled device 30 through the portable apparatus that is also portable. In addition, with various sensors and other means built in the portable apparatus 10 and the mobile apparatus 20, various usable functions can be realized by communication interaction between the portable apparatus 10 and the mobile device 20 or the controlled device 30.

Hereinafter, for illustration but not limitation, particular details of the respective embodiments of the present disclosure will be particularly introduced in examples that the mobile terminal 20 is a common mobile terminal, the controlled device 30 is a common DSLR, the first wireless communication protocol is Bluetooth, and the second wireless communication protocol is infrared ray.

3. Self-Defined Command Identifiers

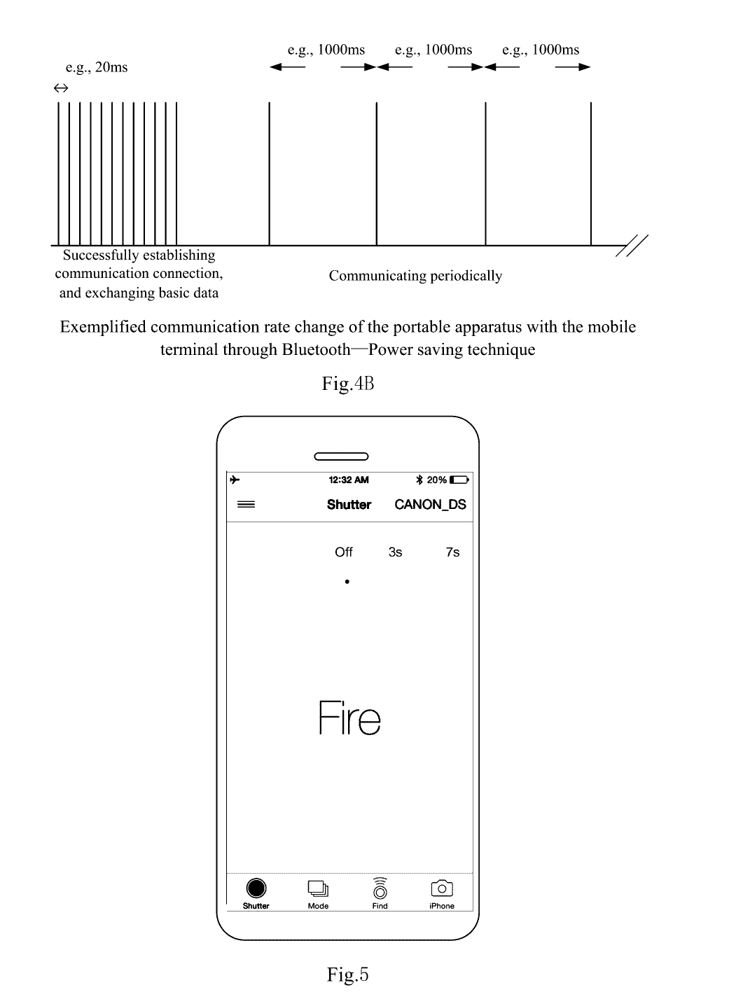

FIG. 3A is an exemplified table (camREMOTE Profile) showing a corresponding relationship between identifiers of self-defined control commands and the infrared instructions supported by cameras according to an embodiment of the present disclosure; and FIG. 3B is an exemplified table showing camera type identifiers and the supported operation type identifiers according to an embodiment of the present disclosure.

Example tables as shown in FIG. 3A and FIG. 3B may be stored in the portable apparatus 10, and the application program in the mobile terminal 20 may also define the same identifier set of the control commands.

As shown in the example table camREMOTE Profile in FIG. 3A, as an example, the first column on the left indicates a short identifier UUID of self-defined control commands according to an embodiment of the present disclosure, the second column indicates the detailed description of the UUID, the third column indicates the length of the value, the fourth column indicates the definition, the fifth column is the value, and the sixth column is the authority. Each one corresponds to a corresponding parameter and operation. For example, the UUID of “0xCA01” means the camera brand for receiving the infrared protocol, whose value includes the PTC code of the camera type of the second column as shown in FIG. 3B, that is, the value of “0x01” means that the camera brand is SONY, and the value of “0x02” means that the camera brand is Canon, and so on. As such, the user can use a mobile terminal 20 to remotely control different camera brands, and the user only needs to input or click the corresponding camera brand on the mobile terminal 20, and the mobile terminal 20 writes a corresponding value into the value of the “0xCA01” line corresponding to the camera brand in the above camREMOTE Profile table stored in the portable apparatus 10 (for example, in the case of SONY, the value is 01). Then, the controller 102 in the portable apparatus 10 will configure an infrared instruction set corresponding to the SONY camera, as shown in FIG. 3B. This enables switching different camera brands and/or model numbers very quickly and conveniently.

The UUID of “0xCA02” in FIG. 3A indicates an instant shutter operation, and if the value is “01”, it means transmitting an instant shutter infrared instruction, and if the value is “02”, it means transmitting a delay shutter, and so on. For example, the user presses an instant shutter button on the mobile terminal 20, then the mobile terminal 20 writes a corresponding value of “01” into the value of the “0xCA02” line in the above camREMOTE Profile table stored in the portable apparatus 10 through the Bluetooth, and then, the portable apparatus 10 transmits the corresponding infrared instruction to the camera through the infrared ray, so that the camera can perform the instant shutter photography operation.

Such design of short identifier UUID can also enable transmitting less data when the mobile terminal 20 communicates with the portable apparatus 10 through the Bluetooth, so as to realize a relatively low package loss rate, the effects of transmission promptness and power saving.

4. Power Saving Design

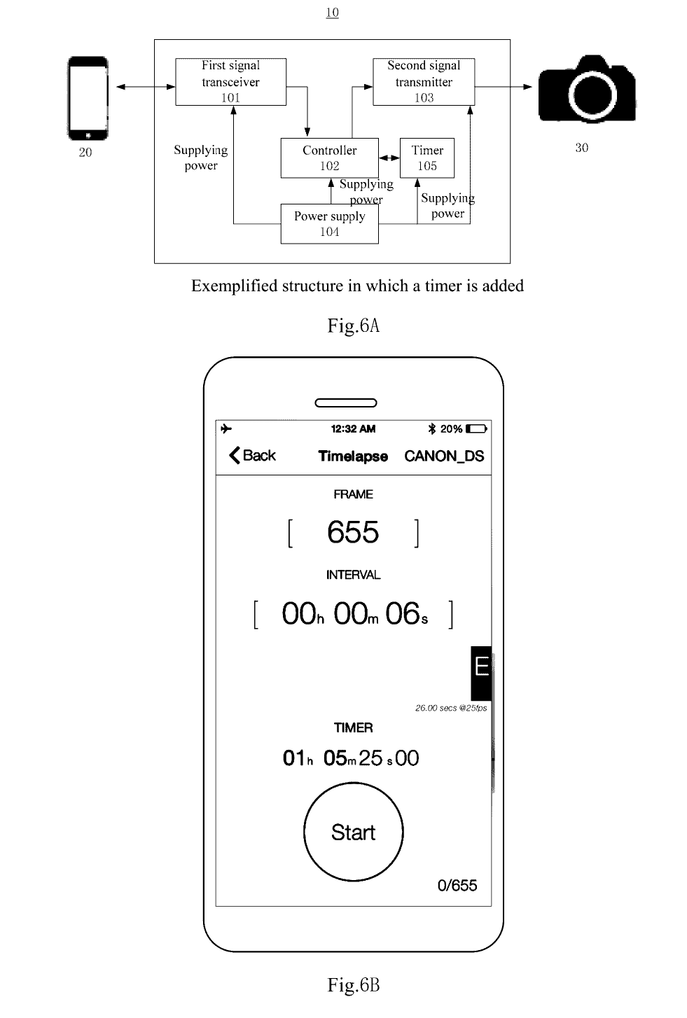

FIG. 4A and FIG. 4B are exemplified timing diagrams showing variations of broadcasting rate and communication rate of the portable apparatus for using the mobile terminal to wirelessly control a controlled device according to an embodiment of the present disclosure and the mobile terminal in for example Bluetooth communication protocol, respectively, for a purpose of power-saving.

After power on (or initiated), the power supply 104 built in the portable apparatus 10 will make the controller 102 and the first signal transceiver 101 broadcast a connecting request to establish communication connection with the mobile terminal 20 within for example a Bluetooth communication range. In an embodiment, if the portable apparatus 10 does not successfully connect with the mobile terminal 20 within a predefined timeout period, for example, when there is no mobile terminal 20 around, the mobile terminal 20 is powered off, off-line, connecting time-out, and connecting unsuccessfully, or when the mobile terminal 20 transmits a termination connection command due to the user's selection, and so on, the power supply 104 may also enter a broadcast mode. In this broadcast mode, the power supply 104 may broadcast the connecting request at a lower rate by providing lower power, for example, by transmitting an Advertising data package (indicating the broadcast mode of the portable apparatus 10, such as perpetual broadcast or limited broadcast) and a Request data package (which may include the name, local name and so on of the portable apparatus 10 itself) (commonly called the “connecting request”). The Advertising Interval of the two types of data packages decides the balance between the power consumption of the portable apparatus 10 and the connection success rate. For example, the connecting request is broadcasted in the Advertising Interval of 1.25 s, and then for example, a battery of CR2032 (calculated as 180 mha) can emit signals for 260 days. Thus, low broadcast rate can save power.

In an embodiment, the lower rate may also be variable. In the case that the probability of the portable apparatus 10 connecting with the mobile terminal 20 is larger than a predefined possibility, the third rate is made to be larger than a predefined rate, while in the case that the probability of the portable apparatus 10 connecting with the mobile terminal 20 is not larger than a predefined possibility, the third rate is made to be not larger than a predefined rate. The case that the probability of the portable apparatus 10 connecting with the mobile terminal 20 is larger than a predefined probability may include, but is not limited to the following: in a period after the power supply 104 of the portable apparatus 10 is turned on; in a period after the portable apparatus 10 is disconnected from the mobile terminal 20; a case that other users may connect the portable apparatus 10 and the mobile terminal 20, and so on. For example, as shown in FIG. 4A, in the case that the power supply 104 of the portable apparatus 10 is initiated for the first time (for example, at the time of the first-time power on, i.e., the user turns on the power supply 104 of the portable apparatus 10 for the first time) (it is considered at this time that the probability of the user wanting to connect the portable apparatus 10 with the mobile terminal 20 is relatively large), a relatively short interval, for example, 1.25 s can be used to broadcast the connecting request, and if, after for example 1 day, the connection is not successful, then a relatively long interval of 2.5 s can be switched into to broadcast the connecting request. Again for example, within 1 day after the portable apparatus 10 disconnects from the mobile terminal 20 (for example, the user voluntarily terminates the connection of the portable apparatus 10 and the mobile terminal 20, or the mobile terminal 20 is offline, powered off, or goes far away from the connecting range, in this case, the probability of the user wanting to reconnect them is relatively large), the relatively short interval of for example 1.25 s is used to broadcast the connecting request, and if the connection is still not successful after 1 day, the relatively long interval of 2.5 s is switched into again. Thus, in practice, normally, a battery of CR2032 (calculated as 180 mha) can last for about a duration of 460 days, which greatly improves availability of the portable apparatus 10 itself with the built-in powers supply, for the user to use the portable apparatus 10 to remotely control the controlled device 30 for a long time, and to prevent the user from waiting for too long time to connect the portable apparatus 10 with the mobile terminal 20, so that the user can feel good connection performance and communication performance while realizing the power saving effect. Of course, this is only an example, but not a limitation. As such, broadcasting the connecting request in a variable speed can further save power and greatly improve the user experience.

Thus, even in the case of disconnecting from the mobile terminal or the mobile terminal being offline, the power supply 104 can broadcast a connecting request at a lower rate, so as to further save power.

Of course, if the connection is successful within the time-out period, the portable apparatus 10 no longer emits the Advertising data package and the Request data package, that is, no longer in the broadcast mode, and then starts to transmit and receive data packages including data frames for communicating with the mobile terminal 20, using a first rate and a second rate as above, which is called a communication mode herein. The power consumptions and the durations for transmitting a broadcast package and transmitting a normal length of the data frame are similar. Thus, if the frequency of the broadcast mode is substantively equal to the frequency of the communication mode after connection, the power consumptions of the portable apparatus 10 under both of broadcast and communication are substantively the same. If the frequency of the broadcast mode is lower than the frequency of the communication mode after connection, the power consumption of the portable apparatus 10 under the broadcast mode is lower than the power consumption under the communication mode. After the portable apparatus is successfully connected with the mobile terminal, the built-in power supply 104 of the portable apparatus 10 may provide a high power to the controller 102 and the first signal transceiver 101, so that the controller 102 exchanges the basic data with the mobile terminal 20 at a high rate through the first signal transceiver 101 (as shown in the left of FIG. 4B, if the communication rate is higher, the period is shorter, for example, the period is for example 20-50 ms). The basic data may include, but is not limited to for example, the information of the portable apparatus, the information of the mobile terminal, the camera type and the model number input by the user and transmitted from the mobile terminal, the setting parameters and so on. After the exchange of the basic data, the power supply 104 may provide a lower power to the controller 102 and the first signal transceiver 101, so that the controller 102 communicates with the mobile terminal 20 at a low rate through the first signal transceiver 101. The communicated data may include, but is not limited to control commands, a connection terminating request and so on. As shown in the left of FIG. 4B, if the communicate rate is lower, the period is longer, for example, the period is 800-3000 ms, and is set as 1000 ms, that is, the communication with the mobile terminal 20 occurs every 1000 ms, and then it can rest for the rest of the time. Of course, the controller 102 of the portable apparatus 10 may further negotiate with the mobile terminal 20 about any rate of the communication frequency when exchanging the basic data for the first time. If the negotiated communication frequency is lower, the power will be consumed less, but correspondingly the timeliness of the communication will be affected, and in contrast, if the communication frequency is higher, the power will be consumed more, and correspondingly the timeliness of the communication will be improved.

Thus, a high-rate consuming-power communication can be first utilized to perform basic data read and write required for communication connecting, for example, the mobile device 20 scanning the portable apparatus 10, reconnecting with the last-successfully-connected portable apparatus 10, requesting parameter information of the portable apparatus 10, the portable apparatus 10 responding to the mobile device 20, and transmitting its own parameter information, or even communication frequency which is agreed on to be used; and then after the basic communication connecting is completed, the power supply 104 can change to run at a low rate and low power consumption according to previously agreed communication frequency, and initiate the communication with the mobile device 20 only when the time period for the communication frequency is reached, and sleep for the rest of the time. As such, not only the first-time communication connecting can be performed at a high rate, saving the user's waiting time, but also, the power is saved after the first-time communication connecting, to maintain long use time, and provide good user experience to the user, which realizes the power saving effect while the user can feel good connection performance and communication performance.

This power saving technology, in which optionally, the connecting request is broadcasted in a higher power and rate when first connecting or wanting to connect as soon as possible, and optionally, if the connection is unsuccessful within a period, the power and the rate will be decreased, and optionally after the successful connection, the higher power and rate are first utilized to exchange basic data, and optionally after exchanging basic data, the power and rate will be decreased to perform other communications, such as transmitting control commands and so on, can creatively and greatly improve the battery performance and endurance and improve user experience.

Now, taking the camera as an example of the controlled device, how the common photography functions in the camera can be realized by the portable apparatus 10 according to respective embodiments of the disclosure will be explained below.

5. Instant Shutter Function, Instant f-Number Adjustment Function, Instant Focus Length Adjustment Function

Most DSLRs can receive infrared instructions, so the users first may turn on the infrared function of the controlled camera 30, so that the controlled camera can periodically receive the infrared instructions around, and the user may turn off the sleep function of the controlled camera when necessary. Then, the user may open an application program of the mobile terminal 20, and turn on the Bluetooth function of the mobile terminal 20. As such, the user can remotely control functions supported by the controlled camera, such as instant shutter, instant F-number adjustment, instant focus adjustment and so on, through the application program in the portable apparatus 10.

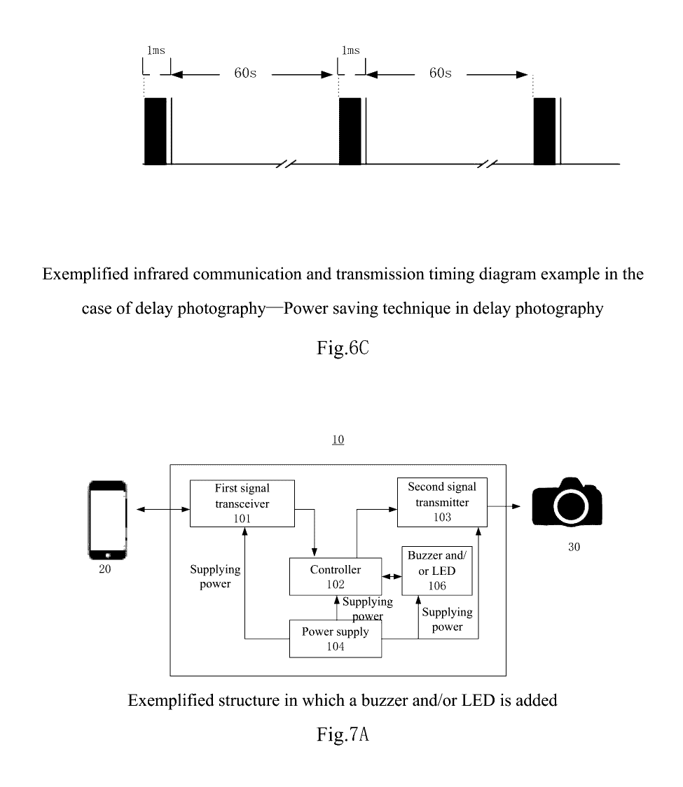

FIG. 5 shows a schematic diagram of a mobile device interface for implementing an instant shutter function according to an embodiment of the present disclosure.

For example, the user can set the delay time as off, and press the instant shutter photography (fire) button on the application program of the mobile terminal 20, and then the mobile terminal 20 can transmit a Bluetooth signal carrying a control command of instant photography to the first signal transceiver 101 of the portable apparatus 10 through Bluetooth, and the controller 102 of the portable apparatus 10 parses the received Bluetooth to obtain the control command of the instant shutter photography, and an infrared signal related to the control command of the instant shutter photography and to be transmitted to the controlled camera 30 can be generated according to the respective tables as shown in FIG. 3, and the infrared signal related to the control command of the instant shutter photography can be transmitted to the controlled camera 30 through the second signal transmitter 103, so that the controlled camera 30 executes the operation of the instant shutter photography according to the infrared signal.

Similarly, in the case of a camera supporting infrared instructions for instant functions such as instant F-number adjustment, instant focus adjustment and so on, through the portable apparatus 10, the above instant functions of such camera can be remotely controlled through the mobile terminal 20, which will not be described in detail.

As such, the portable apparatus 10 can make the user be far away from the controlled camera to perform corresponding operations, so as to prevent the user from bad environment or make the user stay in the indoor warm environment while remotely controlling the camera under bad environment, which may greatly improve the user experience.

6. Time-Lapse Photography Function, Delay Shutter Function, Manual Shutter Adjustment Function in the Time-Lapse Photography and its Power Saving Design

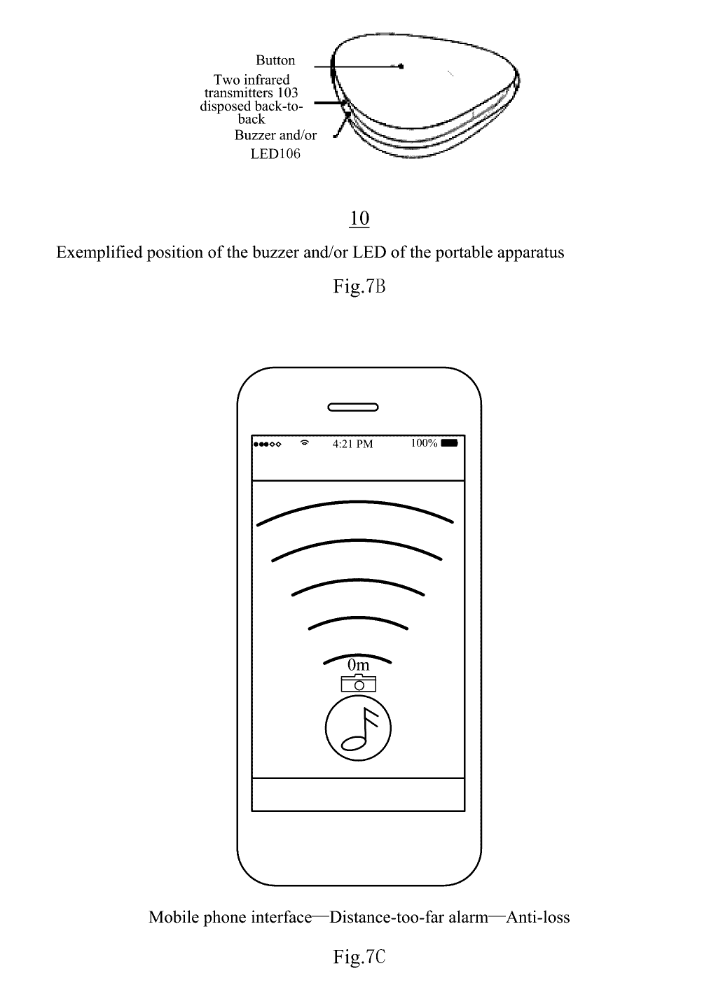

FIG. 6A is a structural diagram showing a portable apparatus for using a mobile terminal to wirelessly control a controlled device according to another embodiment of the present disclosure.

As shown in FIG. 6A, in addition to the first signal transceiver 101, the controlled 102, the second signal transceiver 103, and the power supply 104, the portable apparatus 10 may further include: a timer 105, wherein the controller 102 is configured to, in response to the control command being parsed as a time-lapse photography command, make the timer 105 periodically initiate the built-in power supply 104's power supply, according to the photography period instructed in the time-lapse photography command, so that the controller 102 generates an infrared signal associated with the instant shutter command, and transmits the infrared signal to the controlled device 30 through the second signal transmitter 103, so that the controlled device 30 periodically executes the instant shutter operation.

FIG. 6B shows a schematic diagram of a mobile terminal interface for implementing a time-lapse photography according to an embodiment of the present disclosure. For example, the user can select the number of photos (FRAME), the interval for taking photos (INTERVAL), the total time for the time-lapse photography (TIMER) on the time-lapse photography interface of the application program of the mobile terminal 20, and click a Start button, then, the mobile terminal 20 may transmit a Bluetooth signal (in an example, these parameters can be combined as a data of 16 bits long) carrying the control command of time-lapse photography operation type and time-lapse photography related parameters (for example, FRAME, INTERVAL, TIMER) to the first signal transceiver 101 of the portable apparatus 10 through Bluetooth, and the controller 102 of the portable apparatus 10 parses the received Bluetooth signal to obtain a control command including the time-lapse photography operation type and time-lapse photography related parameters, and then can write these data into the value of the “0xCA04” line in the above camREMOTE profile table stored in the portable apparatus 10. Meanwhile, the photography interval for the time-lapse photography can be written into the timer 105, so that when the timer expires, an infrared signal related with the control command for the instant shutter and to be transmitted to the controlled camera 30 can be generated, and the infrared signal related with the control command for the instant shutter can be transmitted to the controlled camera 30 through the second signal transmitter 103, so that the controlled camera 30 executes the operation of the instant shutter photography at a specific timing according to the infrared signal.

Herein, since most cameras themselves do not have the infrared instruction for the time-lapse photography, the portable apparatus 10 of the technology of the present disclosure can use the built-in timer 105 to periodically transmit an infrared instruction for the instant shutter to realize the time-lapse photography function.

The interface of the time-lapse photography as shown in FIG. 6B is merely an example, and the user may also only define the start time and the end time and the number of the photos, and then the mobile terminal 20 or the portable apparatus 10 automatically converts them into the time interval for the time-lapse photography and writes it into the timer 105.

In addition, most time-lapse photography utilizes a plurality of single shutter to complete, but in some cases, for example, in the case of taking photos of sunrise, the manual shutter mode (Bulb shutter mode, or B mode) of the camera may be turned on, to adjust the shutter speed for taking each photo for the time-lapse photography, and balance amount of light and avoid over-exposure or under-exposure, and in this case, the mobile terminal may also transmit, to the portable apparatus 10, a control command carrying the manual shutter mode and the manual progressive shutter parameters or else parameters, i.e., by how much F-number is to be adjusted when taking each photo, so as to remotely control the controlled camera 30 to perform the time-lapse photography of manual shutter mode.

As such, even in the cast of cameras not supporting the infrared instructions for delay functions such as delay shutter and so on, by the timer 105 built in the portable apparatus 10, the delay time recorded in the timer 105 can be also used by the mobile terminal 20 (for example, selecting the delay time, for example, 3 s, on the user interface as shown in FIG. 5, and clicking Fire) to remotely control the delay shutter function of such camera, which will not be described in detail. In the case of cameras themselves not supporting the delay shutter of for example, any time, the timer 105 built in the portable apparatus 10 can be used to self-define any delay time, and an instant shutter instruction is transmitted to the controlled command 30 when the timer 105 expires, so as to realize the delay shutter function for any delay time.

When performing the time-lapse photography, the portable apparatus 10 may also send data to the mobile terminal 20 through Bluetooth after taking each photo, to notify the number of the photos currently taken, and then the application program of the mobile terminal 20 may immediately update the number of the photos, and the remaining time for the time-lapse photography, and display them on the screen of the mobile terminal 20, so as to facilitate the user's monitoring the progress of the time-lapse photography.

If the user clicks “terminating the current time-lapse photography task” through the mobile terminal 20, the mobile terminal 20 will send this command to the portable apparatus 10, and the portable apparatus 10 writes the terminating instruction “0x04b” into the value of the “0xCA06” line in the above stored camREMOTE profile table, so as to terminate the current task of the portable apparatus 10.

Thus, the portable apparatus 10 can make the user be far away from the controlled camera to perform operations such automatic time-lapse photography and so on, so as to prevent the user from bad environment or make the user stay in the indoor warn environment while remotely controlling the camera under bad environment, without staying near the camera for a long time during the time-lapse photography and even without holding the mobile terminal 20 all the time for operations such automatic time-lapse photography and so on, which may save the user's time and greatly improve the user experience. The user can further utilize the plurality of photos taken for the time-lapse photography to generate a time-lapse-video and so on, which may bring more fun when using the portable apparatus 10 to the user.

FIG. 6C shows an exemplified timing diagram of the portable apparatus, as shown in FIG. 6A, in the case of time-lapse photography, using a timer to transmit an infrared signal to a controlled device through an infrared communication protocol, for a purpose of power-saving.

As shown in FIG. 6C, the built-in power 104 may supply power to the second signal transmitter 103 only when it is to transmit the infrared signal to the controlled device 30, and stop supplying power to the second signal transmitter 103 after the second signal transmitter 103 transmits the infrared signal. In this way, in the case of realizing various time-lapse functions, the power is used only when it is substantively needed to transmit the infrared signal to the controlled device 30 to operate the controlled device 30, this can greatly save power, and maintain long use time, and provide good user experience to the user without affecting various automatic time-lapse operations of the controlled device 30. Normally, the time for transmitting the infrared signal is only for example about 1 ms to 20 ms or else, so especially when performing for example, the time-lapse photography of the camera, assuming that the user requires to take a photo each 1 minute, up to a total of 100 photos, the power supply 104 can provide power for, for example, 1 ms, to transmit the shutter operation signal only when each 1 minute is reached, without constantly supplying power for the whole 100 minutes, as shown in FIG. 6B, which greatly saves power.

7. Too-Far Alarm (Anti-Loss) Function, Find-Apparatus Function

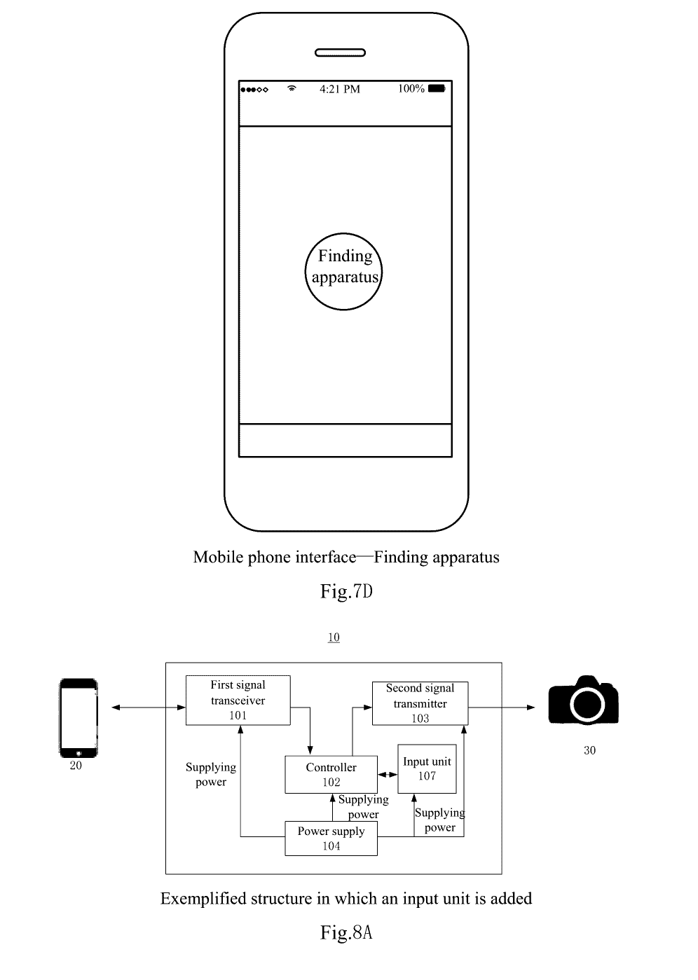

FIG. 7A is a structural diagram showing a portable apparatus for using a mobile terminal to wirelessly control a controlled device according to another embodiment of the present disclosure.

As shown in FIG. 7A, in addition to the first signal transceiver 101, the controller 102, the second signal transmitter 103, and the power supply 104, the portable apparatus 10 may further includes a buzzer and/or a light emitting diode (LED) 106.

FIG. 7B is an exemplified physical position at which the buzzer and/or the LED of the portable apparatus as shown in FIG. 7A is located. As shown in FIG. 7B, the buzzer and the LED are located at the same side of the second signal transmitter (for example, the infrared transmitter) 103 in the portable apparatus 10. This could make the layout more compact. The number of the infrared transmitters as shown in the example of the FIG. 7B may be 2, and they are respectively disposed back-to-back at the two sides of the Printed Circuit Board (PCB) of the portable apparatus 10, in order to enlarge the coverage scope of the infrared transmission as much as possible, and break the limit of the directional transmission and reception of the infrared ray. Of course, this is only an example, but not a limitation.

FIG. 7C is a schematic diagram showing a mobile terminal interface with a too-far alarm (anti-loss) function according to another embodiment of the present disclosure.

As shown in FIG. 7C, the mobile terminal 20 may correspondingly correspond to the distance from the portable apparatus 10 (the radar-like distance as shown in FIG. 7C) by measuring the Received Signal Strength Indication (RSSI) of the signal received at the mobile terminal 20 and transmitted from the portable apparatus 10. When the RSSI is beyond a threshold range, the distance from the portable apparatus 10 is considered to be beyond a threshold range, so that the mobile terminal 20 transmits a control command of too-far alarm to the first signal transceiver 101 of the portable apparatus 10. The controller 102 of the portable apparatus 10 can trigger the buzzer and/or LED 106 to buzz and/or emit light, in response to the control command being parsed as the too-far alarm command. Of course, meanwhile, in addition to the portable apparatus 10 buzzing or emitting light, the mobile terminal 20 itself can notify the user in the form of buzzing or splash screen or prompting dialog box. Thus, the portable apparatus 10 can buzz or emit light or use various prompts of the mobile terminal 20 to notify the user of the distance between the portable apparatus 10 (and the controlled device 30 connected thereto) and the mobile terminal 20 being too far away, so as to prevent the controlled device 10 from being stolen, lost or not safe due to the too-far-way distance.

In another example (not shown), in response to the signal power received at the first signal transceiver 101 of the portable apparatus 10 being lower than the predefined signal power or the power of the built-in power supply 104 being lower than the predefined power threshold, the buzzer and/or LED 106 is triggered to buzz and/or emit light. As such, the portable apparatus 10 itself alarms when it detects itself being far away from the mobile terminal 20, or it lacks power, so as to prompt the user to perform corresponding actions.

FIG. 7D is a schematic diagram showing a mobile terminal interface with a finding-apparatus function according to another embodiment of the present disclosure.

In another example, if the user cannot find where the camera is located, he/she can transmit the control command of finding-apparatus to the portable apparatus 10 by clicking the finding-apparatus button on the user interface of the mobile terminal 20 as shown in FIG. 7D, and the controller 102 of the portable apparatus 10 triggers the buzzer and/or LED 106 to buzz and/or emit light, in response to the control command being parsed as the finding-apparatus command. Thus, the user can find the portable apparatus 10 and the location of the controlled device 30 connected thereto by the mobile terminal 20 as well as the buzzer and/or LED 106 in the portable apparatus 10.

8. Mobile Terminal Autodyne Function, Find-Mobile-Terminal Function

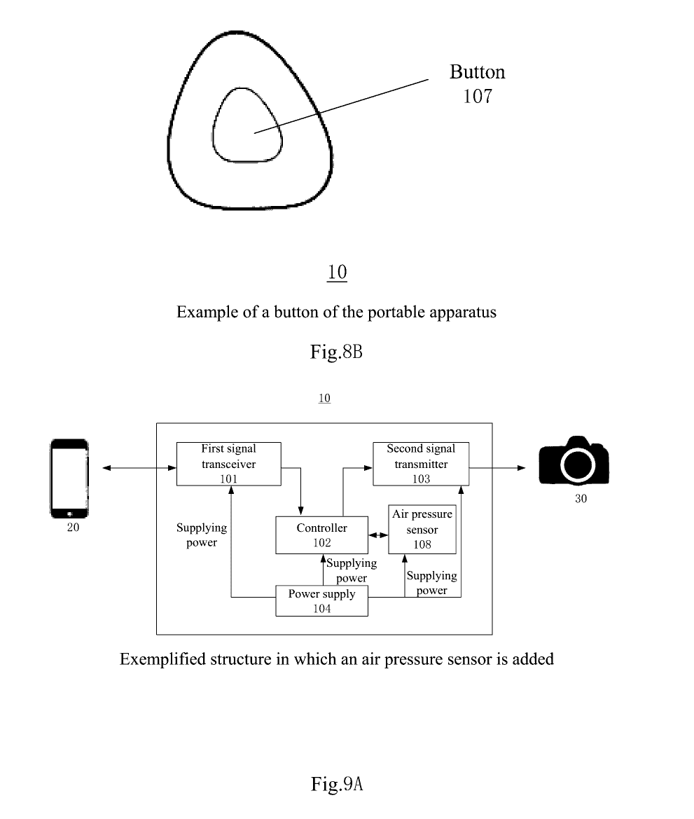

FIG. 8A is a structural diagram showing a portable apparatus for using a mobile terminal to wirelessly control a controlled device according to another embodiment of the present disclosure.

As shown in FIG. 8A, in addition to the first signal transceiver 101, the controller 102, the second signal transmitter 103, and the power supply 104, the portable apparatus 10 may further include: an input unit 107; the controller 102 may be further configured to, in response to the input unit being input with an instruction, transmit an instruction to the mobile terminal 20 through the first communication transceiver 101, so that the mobile terminal 20 performs audio or video alarms, or camera shutter actions. The input unit 107 may include physical buttons, virtual buttons, sliding member, audio input, sensor input and so on.

FIG. 8B is a schematic diagram showing an outer physical shape of an example of an input unit of the portable apparatus as shown in FIG. 8A. As shown in FIG. 8B, the portable apparatus 10 can be configured with a physical button 107, so that the user can easily press the physical button 107. Of course, the physical button 107 and its size and shape are all examples, but not limitations.

As such, if the user wants to find the mobile terminal 20 through the portable apparatus 10, he/she can input instructions (for example, the button being pressed) through the input unit 107, and after receiving the input instruction from the input unit 107, the controller 102 of the portable apparatus can transmit the instruction of for example the button being pressed to the mobile terminal 20 through the first signal transceiver 101, so that the mobile terminal 20 correspondingly performs audio or video alarms, for example buzzing or splash screen, so that the user can be prompted to find out where the mobile terminal 20 is located when the user is looking for the mobile terminal 20.

Then, if the user wants to stop the buzzing or else of the mobile terminal 20, he/she can input an instruction (for example, still the button being pressed) through the input unit 107, and after receiving the input instruction from the input unit 107, the controller 102 of the portable apparatus 10 can transmit the instruction of for example the button being pressed to the mobile terminal 20 through the first signal transceiver 101, so that the mobile terminal 20 correspondingly stops audio or video alarms.

In addition, the application program of the mobile terminal 20 can be used to set the buzzing type of the mobile terminal 20, for example, a dog barking and so on, so that the user can use the portable apparatus 10 to make the mobile terminal 20 bark to interact with the pets.

Similarly, if the user opens the camera photography function with the own camera of the mobile terminal 20, and wants to take a photo of himself/herself, by inputting to the input unit 107 the instruction (for example, the button being pressed), the mobile terminal 20 can perform a shutter action when being in the camera photography function, so that the user does not need to press the shutter button on the mobile terminal 20 with a finger, i.e., the user can implement the self-photography action, even the self-photography far away from the mobile terminal 20, by releasing the hand holding the mobile terminal 20.

Of course, only one button is shown in FIG. 8B, so few functions are designed for the press of this button, however, the technology of the disclosure is not limited hereto, but in fact, there can be a plurality of input units, such as touch display, a plurality of buttons, microphone and so on, so as to design further functions according to these various input units.

9. Thunderstorm Alarm Function

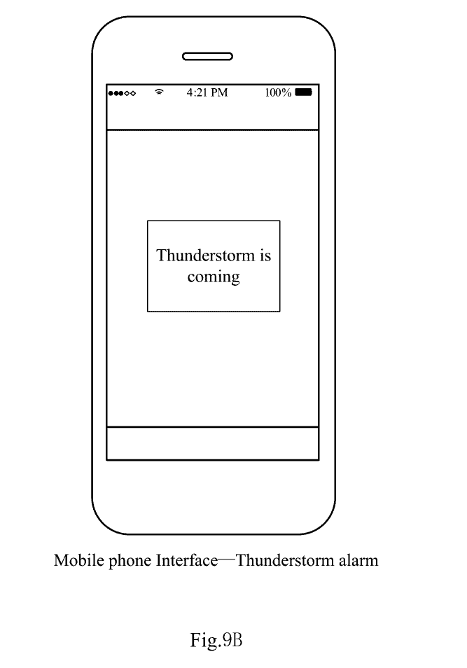

FIG. 9A is a structural diagram showing a portable apparatus for using a mobile terminal to wirelessly control a controlled device according to another embodiment of the present disclosure.

As shown in FIG. 9A, in addition to the first signal transceiver 101, the controller 102, the second signal transmitter 103, and the power supply 104, the portable apparatus 10 may further includes an air pressure sensor 108 configured to sense an air pressure. The controller 102 may be further configured to, in response to the air pressure sensed by the air pressure sensor 108 exceeding a predefined air pressure threshold range, transmit an air-pressure-beyond-scope instruction to the mobile terminal 20 through the first communication transceiver 101, so that the mobile terminal 20 performs audio or video alarm.

Herein, the portable apparatus 10 can further include a timer (unshown) configured to periodically make the air pressure sensor 108 sense the air pressure information. The sensing frequency is set to lower so as to further decrease power consumption. For example, when predicting weather, the period for sensing can be set as Is. Of course, this is only an example, but not a limitation.

FIG. 9B is a schematic diagram showing a mobile terminal interface with a thunderstorm alarm function according to another embodiment of the present disclosure. As shown in FIG. 9B, when the mobile terminal 20 receives an air-pressure-beyond-scope instruction transmitted from the portable apparatus 10, a prompt of for example thunderstorm alarm is displayed on the display screen of the mobile terminal 20.

As such, when the air pressure is increased before for example thunderstorm, the user of the mobile terminal 20 can be informed so that the user may retrieve the controlled device 30 in time to prevent the camera from being wet.

10. Highest-Point Photography Function

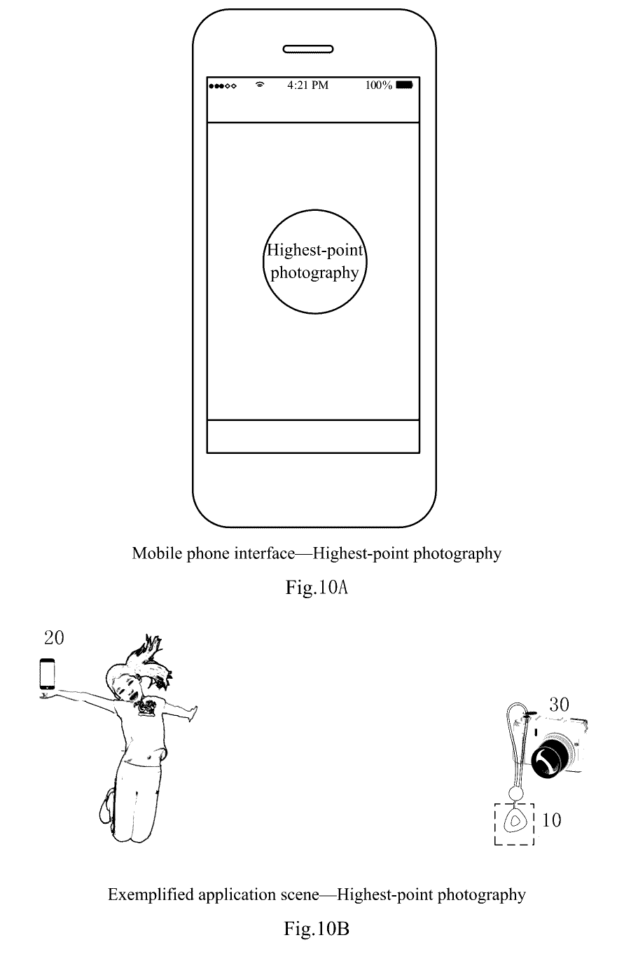

FIG. 10A is a schematic diagram showing a mobile terminal interface with a highest-point photography function according to another embodiment of the present disclosure.

When the user wants to take a sporty photo of himself/herself when he/she jumps at the highest point, the user may click a highest-point photography button on the application program of the mobile terminal 20 as shown in FIG. 10A, then the user jumps with the hand holding the mobile terminal 20, the mobile terminal 20 can determine when the mobile terminal 20 is at the jumping-highest-point by using an acceleration sensor and/or a gyroscope, and transmit a highest-point photography command to the first signal transceiver 101 of the portable apparatus 10. The controller 102 of the portable apparatus can, in response to the control command being parsed as the highest-point photography command, transmit a shutter command to the controlled camera 30 through the second communication transmitter 103, so that the controlled camera 30 performs the shutter operation at this moment.

It is useful to use the acceleration sensor and/or gyroscope of the mobile terminal 20 to determine whether the mobile terminal 20 is at the jump highest point when the user needs to take a photo at the jump highest point, which can accurately judge when the user jumping with the mobile terminal 20 is at the jump highest point, without the user judging the timing of the highest point himself/herself.

FIG. 10B is an illustrative diagram of an application scene of the highest-point photography function according to another embodiment of the present disclosure. As shown in FIG. 10B, when the person on the left jumps holding the mobile terminal 20, the portable apparatus 10 can make the controlled camera 30 take a photo when the person jumps at the highest point, and capture the best sporty photo and provide good user experience.

Of course, the above description merely provides that the highest point photography function of the controlled device 30 is realized through the portable apparatus 10 by using the acceleration sensor and/or the gyroscope built in the mobile terminal 20, however, the technology of the present disclosure is not limited thereto, and the mobile terminal 20 can further include other various sensors (for example, temperature sensor, humidity sensor, ultraviolet sensor and so on), input units or functionality peripherals, such as compass, microphone, Bluetooth earphone and so on, and the portable apparatus 10 of the technology of the present disclosure can be used, in combination with the features of the mobile terminal 20, to develop various utility functions related with the controlled device 30, for example, by combining the acceleration sensor and/or the gyroscope to realize a sport detection-pedometer, sleep detection function and other functions to be developed which will not be described one by one herein.

11. Execution Progress, Various Parameters Inquiry Function

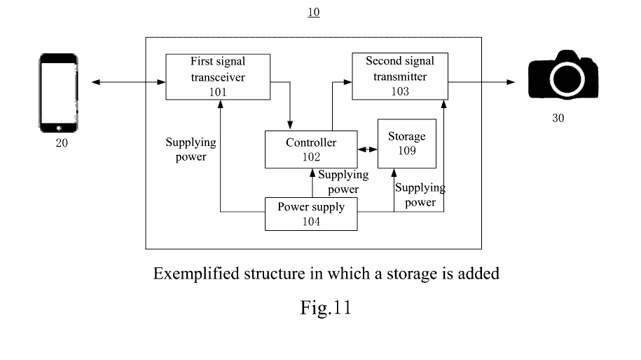

FIG. 11 is a structural diagram showing a portable apparatus for using a mobile terminal to wirelessly control a controlled device according to another embodiment of the present disclosure.

As shown in FIG. 11, in addition to the first signal transceiver 101, the controller 102, the second signal transmitter 103, and the power supply 104, the portable apparatus 10 may further include: a storage 109 configured to store at least one of the following: types of the controlled devices, and the corresponding executable operation types; the types and parameters of the operations to be executed in the control command; the execution progresses of the control commands and so on. The controller 102 of the portable apparatus may be configured to, in response to the control command being parsed as an inquiry command, transmit the content to be inquired as stored in the storage 109 to the mobile terminal 20 through the first communication transceiver 101. As such, the user can inquire the current state of the controlled device from the portable apparatus 10 through a different mobile terminal 20 (but not necessarily the mobile terminal 20 originally issuing the control command), for example, whether there is an on-going task, the type of the controlled device and the corresponding executable operation type, the type and parameter of the operation to be executed, execution progress and so on.

For example, as mentioned above, during the progress of the time-lapse photography function, in addition to writing various parameters of the time-lapse photography (for example, the start time, the number of the photos, the photography interval of the time-lapse photography) into the 0xCA04 line in the above camREMOTE profile table stored in the storage 109 of the portable apparatus 10, the past time for the time-lapse photography task can be written into the value of the 0xCA05 line, and the number of photos currently taken can be written into the value of the 0xCA07 line. As such, the user can use a even different mobile terminal 20 (which may not necessarily be the mobile terminal 20 that initially made the control command) to inquire the past time, the remaining time and the number of the photos already taken for the time-lapse photography from the portable apparatus 10.

Of course, the particular shape of the portable apparatus, the shape of the mobile phone, the shape of the camera, the application program interfaces, the buttons, the prompts, the camera model numbers, the Bluetooth and infrared communication protocol, the period length, the related functions, the tables, the values, the people appearances and so on in the above description and related drawings are only examples but not limitations. Although the drawings of the present disclosure only draw a few parts of the portable apparatus 10, any one or more of the above-mentioned timer 105, the buzzer and/or LED 106, the input unit 107, the air pressure sensor 108, the storage 109 and other possible parts added to the portable apparatus 10 can simultaneously exist in the portable apparatus 10, to make the portable apparatus 10 have multiple functions at the same time.

Thus, with the various embodiments of the technology of the present disclosure, the user can easily use the portable mobile terminal 20 to remotely and wirelessly control the controlled device 30 through the portable apparatus that is also portable. In addition, with various sensors and other means built in the portable apparatus 10 and the mobile apparatus 20, various usable functions can be realized by communication interaction between the portable apparatus 10 and the mobile device 20 or the controlled device 30.

12. General Flowchart of a Method According to the Technology of the Present Disclosure

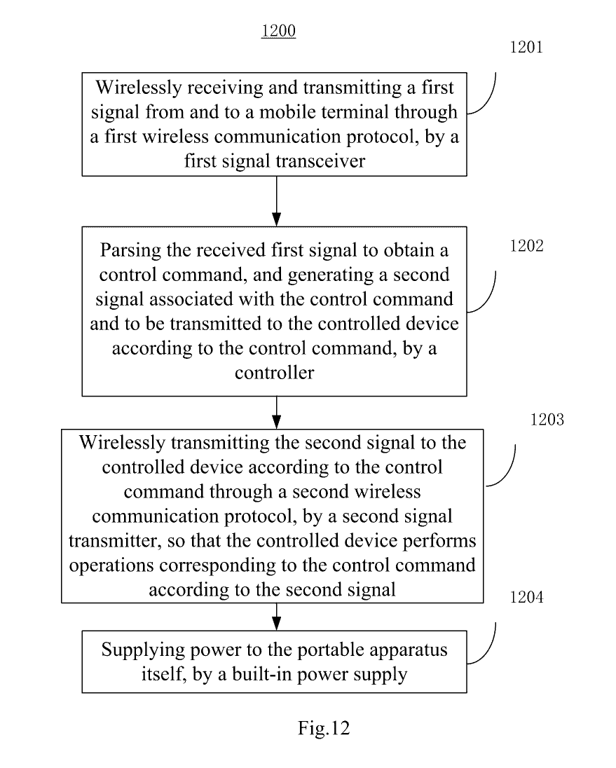

FIG. 12 is a flowchart showing a method for a portable apparatus for using a mobile terminal to wirelessly control a controlled device according to another embodiment of the present disclosure.

As shown in FIG. 12, a method for a portable apparatus to use a mobile terminal to wirelessly control a controlled device includes step 1201 of wirelessly receiving and transmitting a first signal from and to a mobile terminal through a first wireless communication protocol, by a first signal transceiver; step 1202 of parsing the received first signal to obtain a control command, and generating a second signal associated with the control command and to be transmitted to the controlled device according to the control command, by a controller; step 1203 of wirelessly transmitting the second signal to the controlled device according to the control command through a second wireless communication protocol, by a second signal transmitter, so that the controlled device performs operations corresponding to the control command according to the second signal; and step 1204 of supplying power to the portable apparatus itself, by a built-in power supply.

Other steps of the method for a portable apparatus to use a mobile terminal to wirelessly control a controlled device according to another embodiment of the present disclosure can be developed in combination with the particular structures and functions of the portable apparatus in the above drawings and description, and a person skilled in the art, after reviewing the above description, can conceive particular steps by using the particular structure of the portable apparatus, to realize various functions, which will not described in detail.

Thus, with the various embodiments of the technology of the present disclosure, the user can easily use the portable mobile terminal 20 to remotely and wirelessly control the controlled device 30 through the portable apparatus that is also portable. In addition, with various sensors and other means built in the portable apparatus 10 and the mobile apparatus 20, various usable functions can be realized by communication interaction between the portable apparatus 10 and the mobile device 20 or the controlled device 30.

To be noted, the advantages, effects, and so on are merely examples but not limitations, these advantages, effects and so on can not be considered as necessary for the respective embodiments of the invention.

The block diagrams of the devices, apparatuses, equipments and systems in the present disclosure are merely illustrative examples, but it is not intended or implied to necessarily connect, configure or dispose them as shown in the block diagrams. As will be appreciated, a person skilled in the art can connect, configure and dispose these devices, apparatuses, equipments and systems in any ways. The terms such as “include”, “comprise”, “have” and so on are open terms, which means “include but not be limited to” and is exchangeable with it. The terms such as “or” and “and” used herein means a term of “and/or”, and can be exchangeable with it, unless explicitly otherwise indicated. The term “such as” used herein means “for example, but not limited to”, and can be exchangeable with it.

The steps and flowcharts in the present disclosure and the above description are merely illustrative examples, but are not intended or implied to necessarily perform the steps of the respective embodiments as shown. As will be appreciated, a person skilled in the art can perform the steps of the above embodiments in any orders. The terms such as “thereafter”, “then”, “next” and so on are not intended to limit the order of the steps; these terms are only used to lead the readers to read the description of these methods. In addition, the particles such as “a”, “an” or “this” citing a single element can not be explained as limiting this element to a single one.

The operations of the above mentioned methods can be performed by any suitable means capable of performing corresponding functions. The means may include various hardware and/or software components and/or modules, including but not limited to circuits, ASICs or processors.

The various illustrative logical blocks, modules, and circuits described may be implemented or performed with a general purpose processor, a digital signal processor (DSP), an ASIC, a field programmable gate array signal (FPGA), or other programmable logic device (PLD), discrete gate, or transistor logic, discrete hardware components, or any combination thereof designed to perform the functions described herein. The general purpose processor may be a microprocessor, but in the alternative, the processor may be any commercially available processor, controller, microcontroller, or state machine. The processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure, may be embodied directly in hardware, in a software module executed by a processor, or in a combination of the two. A software module may reside in any form of tangible storage medium (compute readable medium).

Some examples of storage media that may be used include random access memory (RAM), read only memory (ROM), flash memory, EPROM memory, EEPROM memory, registers, a hard disk, a removable disk, a CD-ROM and so forth. A storage medium may be coupled to a processor such that the processor can read information from, and write information to, the storage medium. In the alternative, the storage medium may be integral to the processor. A software module may be a single instruction, or many instructions, and may be distributed over several different code segments, among different programs, and across multiple storage media.

The methods disclosed herein comprise one or more actions for achieving the described method. The method and/or actions may be interchanged with one another without departing from the scope of the claims. In other words, unless a specific order of actions is specified, the order and/or use of specific actions may be modified without departing from the scope of the claims.

The functions described may be implemented in hardware, software, firmware, or any combination thereof. If implemented in software, the functions may be stored as one or more instructions on a tangible computer-readable medium. A storage medium may be any available tangible medium that can be accessed by a computer. By way of example, and not limitation, such computer-readable media can comprise RAM, ROM, EEPROM, CD-ROM, or other optical disk storage, magnetic disk storage, or other magnetic storage devices, or any other tangible medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray® disc where disks usually reproduce data magnetically, while discs reproduce data optically with lasers.

Thus, a computer program product may perform operations presented herein. For example, such a computer program product may be a computer readable tangible medium having instructions tangibly stored (and/or encoded) thereon, the instructions being executable by one or more processors to perform the operations described herein. The computer program product may include packaging material.

Software or instructions may also be transmitted over a transmission medium. For example, software may be transmitted from a website, server, or other remote source using a transmission medium such as a coaxial cable, fiber optic cable, twisted pair, digital subscriber line (DSL), or wireless technology such as infrared, radio, or microwave.

Further, modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a CD or floppy disk, etc.), such that a user terminal and/or base station can obtain the various methods upon coupling or providing the storage means to the device. Moreover, any other suitable technique for providing the methods and techniques described herein to a device can be utilized.

Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of indicates a disjunctive list such that, for example, a list of “at least one of A, B, or C” means A or B or C, or AB or AC or BC, or ABC (i.e., A and B and C). Further, the term “exemplary” does not mean that the described example is preferred or better than other examples.

Various changes, substitutions, and alterations can be made to the techniques described herein without departing from the technology of the teachings as defined by the appended claims. Moreover, the scope of the disclosure and claims is not limited to the particular aspects of the process, machine, manufacture, composition of matter, means, methods, and actions described above. Processes, machines, manufacture, compositions of matter, means, methods, or actions, presently existing or later to be developed, that perform substantially the same function or achieve substantially the same result as the corresponding aspects described herein may be utilized. Accordingly, the appended claims include within their scope such processes, machines, manufacture, compositions of matter, means, methods, or actions.

The preceding description of the disclosed aspects is provided to enable any person skilled in the art to make or use the present invention. Various modifications to these aspects will be readily apparent to those skilled in the art, and the generic principles defined herein may be applied to other aspects without departing from the scope of the invention. Thus, the present invention is not intended to be limited to the aspects shown herein but is to be accorded the widest scope consistent with the principles and novel features disclosed herein.

The foregoing description has been presented for purposes of illustration and description. Furthermore, the description is not intended to limit embodiments of the invention to the form disclosed herein. Although a number of exemplary aspects and embodiments have been discussed above, a person of skill in the art will recognize certain variations, modifications, permutations, additions, and sub-combinations thereof.

1. A portable apparatus for wirelessly controlling a controlled device by using a mobile terminal, comprising:
a first signal transceiver configured to wirelessly receive and transmit a first signal from and to the mobile terminal through a first wireless communication protocol;
a controller configured to parse the received first signal to obtain a control command, and generate a second signal associated with the control command and to be transmitted to the controlled device according to the control command;
a second signal transmitter configured to wirelessly transmit the second signal to the controlled device according to the control command through a second wireless communication protocol, so that the controlled device performs operations corresponding to the control command according to the second signal; and
a built-in power supply configured to supply power to the portable apparatus.

2. The portable apparatus as claimed in claim 1, wherein the portable apparatus is electrically isolated from the controlled device, and the portable apparatus is capable of being physically connecting to the controlled device through an insulated flexible connecting unit or a rigid connecting unit.

3. The portable apparatus as claimed in claim 1, wherein:
the first wireless communication protocol includes a Bluetooth communication protocol, and the second wireless communication protocol includes an infrared communication protocol,
the controlled device is capable of receiving an infrared signal to operate, and the mobile terminal is capable of receiving and transmitting a Bluetooth signal.

4. The portable apparatus according to the claim 1, wherein:
the controlled device includes at least one of the following:
digital camera, Digital Single Lens Reflex camera, camcorder, recorder, projector, television, air-conditioner,
the mobile terminal includes at least one of the following:
mobile telephone, notebook computer, tablet computer, personal digital assistant, Bluetooth earphone;
the control command instructs at least one of the following operations:
instant shutter, delay shutter, time-lapse photography, focusing, videotaping, adjusting the focus, adjusting the shutter speed, adjusting the aperture, manual shutter mode, instant power on/off, power on/off by alarm,
the control command includes a type of the controlled device and a type and parameters of the operation to be executed by the controlled device.

5. The portable apparatus as claimed in claim 1, wherein:
after the portable apparatus is successfully connected with the mobile terminal, the built-in power supply supplies a first power to the controller and the first signal transceiver, so that the controller exchanges basic data with the mobile terminal at a first rate through the first signal transceiver, and after exchanging the basic data, the built-in power supply supplies a second power to the controller and the first signal transceiver, so that the controller communicates with the mobile terminal at a second rate through the first signal transceiver,
wherein the second power is lower than the first power, and the second rate is lower than the first rate,
the built-in power supply supplies power to the second signal transmitter only when the second signal transmitter is to transmit the second signal, and stops supplying power to the second signal transmitter after the second signal transmitter transmits the second signal,
wherein in response to the controller not successfully connecting with the mobile terminal through the first signal transceiver within a predefined timeout period, the built-in power supply supplies a third power to the controller and the first signal transceiver, and broadcast a connecting request at a third rate, wherein the third power is lower than the second power, and the third rate is lower than the second rate.

6. The portable apparatus as claimed in claim 5, wherein the third rate is variable, and in a case that a probability of the portable apparatus connecting with the mobile terminal is larger than a predefined possibility, the third rate is larger than a predefined rate, and in a case that a probability of the portable apparatus connecting with the mobile terminal is not larger than the predefined possibility, the third rate is not larger than the predefined rate,
wherein the case that the probability of the portable apparatus connecting with the mobile terminal is larger than a predefined probability includes at least one of the following:
in a period after the built-in power supply of the portable apparatus is turned on;
in a period after the portable apparatus is disconnected from the mobile terminal.

7. The portable apparatus as claimed in claim 1, wherein the control command is comprised of different identifiers for different operations, and its data length is smaller than a predefined data length.

8. The portable apparatus as claimed in claim 1, further comprising:
a timer;
the controller is configured to, in response to the control command being parsed as a time-lapse photography command, make the timer periodically initiate the supply of power by the built-in power supply, according to a photography period instructed in the time-lapse photography command, so that the controller generates the second signal associated with an instant shutter command, and transmits the second signal to the controlled device through the second signal transmitter, causing the controlled device to periodically execute an instant shutter operation.

9. The portable apparatus as claimed in claim 1, further comprising:
a buzzer and/or a light emitter diode (LED), wherein the controller is further configured to perform one or more of the following:
in response to the control command being parsed as a distance-too-far alarm command, trigger the buzzer and/or the LED to buzz and/or light, wherein the distance-too-far alarm command is issued when a distance between the mobile terminal and the portable apparatus as measured by the mobile terminal exceeds a predefined distance threshold,
in response to a signal power received by the first signal transceiver is lower than a predefined power threshold or the power of the built-in power supply is lower than the predefined power threshold, trigger the buzzer and/or the LED to buzz and/or light,
in response to the control command being parsed as a find-apparatus command, trigger the buzzer and/or the LED to buzz and/or light, wherein the find-apparatus command is issued by the mobile terminal when a find-apparatus button on the mobile terminal is clicked.

10. The portable apparatus as claimed in claim 1, further comprising:
an input unit; the controller is further configured to, in response to the input unit being input with an instruction, transmit an instruction to the mobile terminal through the first communication transceiver, so that the mobile terminal performs audio or video alarms, or camera shutter actions.

11. The portable apparatus as claimed in claim 1, further comprising:
an air pressure sensor configured to sense an air pressure;
wherein the controller is further configured to, in response to the air pressure sensed by the air pressure sensor exceeding a predefined air pressure threshold range, transmit an instruction to the mobile terminal through the first communication transceiver, so that the mobile terminal performs audio or video alarms.

12. The portable apparatus as claimed in claim 1, wherein:
the controller is further configured to, in response to the control command being parsed as a highest-point photography command, transmit a shutter command to the controlled device through the second communication transmitter, so that the controlled device performs a shutter operation,
wherein the highest-point photography command is issued by the mobile terminal when the mobile terminal is determined to be at a jump highest point by using an acceleration sensor and/or a gyroscope.

13. The portable apparatus as claimed in claim 1, further comprising:
a storage configured to store at least one of the following:
a type of the controlled device and a type of the corresponding executable operation;
a type and parameters of the operation to be executed in the control command;
an execution progress of the control command,
wherein the controller is configured to, in response to the control command being parsed as an inquiry command, transmit content to be inquired as stored in the storage to the mobile terminal through the first communication transceiver.

14. A method for a portable apparatus to use a mobile terminal to wirelessly control a controlled device, comprising:
wirelessly receiving and transmitting a first signal from and to the mobile terminal through a first wireless communication protocol, by a first signal transceiver;
parsing the received first signal to obtain a control command, and generating a second signal associated with the control command and to be transmitted to the controlled device according to the control command, by a controller;
wirelessly transmitting the second signal to the controlled device according to the control command through a second wireless communication protocol, by a second signal transmitter, so that the controlled device performs operations corresponding to the control command according to the second signal; and
supplying power to the portable apparatus itself, by a built-in power supply.

15. A non-transitory computer recordable medium on which a computer executable program is recorded, the computer executable program, when being run, making a portable apparatus to perform a method for the portable apparatus to use a mobile terminal to wirelessly control a controlled device, the method comprising:
wirelessly receiving and transmitting a first signal from and to the mobile terminal through a first wireless communication protocol, by a first signal transceiver;
parsing the received first signal to obtain a control command, and generating a second signal associated with the control command and to be transmitted to the controlled device according to the control command, by a controller;
wirelessly transmitting the second signal to the controlled device according to the control command through a second wireless communication protocol by a second signal transmitter, so that the controlled device performs operations corresponding to the control command according to the second signal; and
supplying power to the portable apparatus itself, by a built-in power supply.

16. A computer executable program, when being run, making a portable apparatus to perform a method for the portable apparatus to use a mobile terminal to wirelessly control a controlled device, the method comprising:
wirelessly receiving and transmitting a first signal from and to the mobile terminal through a first wireless communication protocol, by a first signal transceiver;
parsing the received first signal to obtain a control command, and generating a second signal associated with the control command and to be transmitted to the controlled device according to the control command, by a controller;
wirelessly transmitting the second signal to the controlled device according to the control command through a second wireless communication protocol by a second signal transmitter, so that the controlled device performs operations corresponding to the control command according to the second signal; and
supplying power to the portable apparatus itself, by a built-in power supply.

17. The portable apparatus as claimed in claim 1, wherein the first signal is an externally input operative instruction signal representative of an externally input operative instruction.

18. (canceled)

19. (canceled)

20. (canceled)
